(19) United States
(12) Patent Application Publication
(10) Pub. No.: US 2006/0127791 A1
(43) Pub. Date: Jun. 15, 2006

(54) Creation of different gloss values in print

(75) Inventors: Domingo Rohde, Kiel (DE); Detlef Schulze-Hagenest, Molfsee (DE); Dinesh Tyagi, Fairport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/349,796

(22) Filed: Feb. 8, 2006

(30) Foreign Application Priority Data
Aug. 12, 2004 (DE) 103 37 158.3
Aug. 12, 2004 (WO) PCT/US04/26182

(51) Int. Cl. G03G 15/20

(52) U.S. Cl. 430/111.4; 430/124

(57) ABSTRACT

The use of a clear toner with a viscosity in the range of 6.2 Pa·s to 1.5 Pa·s at a temperature of 120° C. for creating a higher gloss value in the range of 28 to 47 at an angle of 60°.

### FIELD OF THE INVENTION

The invention pertains to a process, and toner, for imaging a printing medium during which, in order to produce a higher gloss value in selected areas of a printing format, preferably in areas that contain pictorial elements, such areas are imprinted, prior to fusing, with a colorless toner that has higher gloss values than at least one additional toner that is being used.

### BACKGROUND OF THE INVENTION

When printing media are imaged, a printing format is created that can generally be sub-divided into different kinds of areas. These different areas can be categorized as those containing:

a) only pictorial elements;

b) only textual elements; and

c) both textual and pictorial elements.

The areas under categories a) and c) can be grouped together as areas containing pictorial elements. Pictorial elements are defined as, for example, graphics and photographs. Areas that contain both text and pictorial elements can be considered graphics with inscriptions or photographs with imprinted text, or the like.

In the graphics industry it is standard practice to select a dull appearance for the text that is contained in a printing format. A dull image area has a relatively low gloss value. Alternatively, a relatively high gloss value is desired for pictorial elements. The gloss value can be measured at different angles. In the following application, the gloss value is referenced at a 60° angle of measurement. Refer to the ASTM D 523 standard for other parameters.

In conventional electrophotographic color printing machines, a printing format is created by superimposing different colored toner images upon each other. These toner images are either directly transferred onto a printing medium by printing units, whereby they are superimposed upon each other, or they are transferred onto a transfer medium located between the individual printing units and the printing medium and are then transferred from this transfer medium onto the printing medium in one step. The toners that have already been transferred onto the printing medium are then fused onto the printing medium in a fuser mechanism.

In an electrophotographic printing machine, for example, the colors CMYK can be transferred onto the printing medium by the printing units. If both text and pictorial elements are imprinted on the printing medium the same black toner will be used for both areas. Such toner is generally optimized for a high gloss value so that the pictorial elements are not negatively affected, however, consequently an undesirably high gloss is consequently unavoidable in the text areas.

Therefore, in a printing job printing media is imprinted sheet by sheet, only containing text, these sheets are often imprinted separately in single-color printing machines using a dull, black toner. The text is then more easily readable and the sheets are then imprinted in a color printing machine with the areas containing pictorial elements, so that a positive general result is obtained.

However, a problem arises with a printing process that uses two different printing machines, one for the pictorial elements and one for the text, when a page contains both text and pictorial elements. Nowadays, this is often the case. In addition, the use of two printing machines for one printing job is impractical.

Consequently, in patent specification U.S. Pat. No. 5,234,783, it was proposed that in a color printing machine a fifth colorless toner be transferred onto the printing medium. This toner would then have a high gloss value, for example, the same gloss value as that of the CMY toner. Then, a toner with a low gloss value can be used as the black toner K. Thus, only this dull, black toner would be used in text areas. Accordingly, in areas containing pictorial elements a high gloss can be achieved even for the black areas where the colorless toner is applied on top of the layer of black toner, resulting in the achievement of a desired high gloss value. If text is to be imprinted onto a pictorial element, use of the colorless toner can be selectively avoided. The areas on which the colorless toner is to be applied can be selected manually and/or by an automatic analysis of the print data.

### SUMMARY OF THE INVENTION

The goal of the subject invention is to improve the process proposed in U.S. Pat. No. 5,234,783, issued on Aug. 10, 1993 in the name of Ng.

The goal of the invention is achieved with respect to the process by the use of a clear toner with a viscosity in the range of 6.2 Pa·s to 1.5 Pa·s, at a temperature of 120° C. for creating a higher gloss value of 28 to 47 at an angle of 60°. Beneficially, toner images with gloss values within the suggested range can be achieved with toners that have such viscosity values at a temperature of 120° C. Thus, printing formats can be created that have higher gloss values in areas containing pictorial elements than those in areas that contain only text. A toner with a gloss value that is desirable for text, for example, a gloss value of 5, can be used as the black toner.

### DETAILED DESCRIPTION OF THE INVENTION

Beneficially, an appropriate colorless toner can be selected that will produce the appearance that is desired for the multi-sheet printing job. This colorless toner can then be applied only to those areas of the areas containing pictorial elements, which are at least partially formed by the black toner. By using this approach, the areas containing pictorial elements achieve a uniformly high gloss value while the text areas retain their appropriately dull appearance.

In this initial, conceivable embodiment, the colorless toner is not applied to areas that are formed only by toner images containing the CMY colors. In a second embodiment, provision is made for the colorless toner to also be applied to areas that are formed only by toner images in the CMY colors. In this regard, the CMY toners can be used for all possible print jobs with regard to the different glosses that are desired. In such cases, CMY toners are selected with the lowest desirable gloss value, i.e., 28. If the areas containing pictorial elements are to receive a gloss value that exceeds this value, a colorless toner with an appropriately higher gloss value can be used to achieve this result.

If the lowest gloss value is desired, the colorless toner will then also have this lowest gloss value. The pictorial elements consisting of black toner will also be imprinted with colorless toner in this embodiment, while the purely textual areas will continue to be dull.

Beneficially, if in two different print jobs the areas containing pictorial elements are intended to have different glosses, only the colorless toner needs to be different for each of the print jobs, and the same CMYK toners can be used for both print jobs. For all of the processes, provision can be made for areas containing pictorial elements text to intentionally not be imprinted with colorless toners, so that here, too, the dull appearance will remain.

For further embodiments, reference is made to U.S. Pat. No. 5,234,783.

It is also possible, in particular, to use the colorless toner in a monochrome printing machine. For this purpose a second printing unit can be made available. In this case, selected areas can be given a higher gloss value as well. Such areas, for example, can be those that contain graphics.

In a particularly beneficial stage of the process, provision is made for the colorless toner and for the minimally single additional toner to be fused onto the printing medium in a contact-free method, preferably by a microwave fuser mechanism.

When fuser rollers are used, the gloss value of the printing format is consistently affected. In extreme cases, a higher gloss value consistently results, regardless of the toner used. When contact-free fuser mechanisms are used, the gloss value remains essentially unaffected by the fusing process, so that the resulting gloss value is solely a function of the toners used and possibly of the fuser temperature.

In addition, a goal of the subject invention is to disclose an improve colorless toner that can be used in an imaging process in which areas containing pictorial elements achieve a higher gloss value than areas containing text only.

The goal of the invention is achieved through a colorless toner that has a gloss value between 28 and 47, at an angle of 60°, and a viscosity in the range of 6.2 Pa·s and 1.5 Pa·s at a temperature of 120°. Such a colorless toner is derived, for example, from what are actually color toners with appropriate properties to which no color pigments are added. The most varied gloss values possible for the areas of a printing format containing pictorial elements can be achieved through use of such colorless toners.

In a particularly beneficial embodiment, the colorless toner has a gloss value of 28, at a viscosity of 6.2 Pa·s, at a temperature of 120° C. A desired gloss value of 28 at 60° C. can be achieved with this colorless toner, in particular, when the fusing temperature is in the range of 120° C. to 160° C. This is useful whenever areas of the resulting printing format that contain pictorial elements are intended to remain relatively dull.

In a further beneficial embodiment, the colorless toner has a gloss value of 43, at a viscosity of 4.8 Pa·s, at a temperature of 120° C.

Areas of high gloss should have a gloss value of about 47. For this purpose, provision is beneficially made for a colorless toner with a gloss value of 47, at a viscosity of 1.5 Pa·s, at a temperature of 120° C.

An example, to which however the invention is not limited, and from which additional embodiments according to the invention can be derived, is described below.

Toners containing a binding agent TF-90 are used as CMY toners. Such toners have a viscosity of 1.5 Pa·s, at a temperature of 120° C.

A toner containing carbon black on a base of the binding agent T-100 is used as the K toner. This toner has a viscosity of 60 Pa·s, at a temperature of 120° C.

The viscosity is always determined by a rheometer from the Rheometrics RDA 700 Company at 120° C. and 1 rad/s with parallel plates.

The colorless toner is based upon the same base as the color toners, i.e., on the binding agent TF-90. It also has the same viscosity of 1.5 Pa·s and contains no color pigments. The toners were applied to 118 g/m² glossy, coated paper. 0.45 mg/cm² of CMYK toner was applied in each case to glossy, coated paper.

Subsequently, parts of the area that was formed by the K toner were imprinted with the colorless toner. A second part of this imaged area did not receive colorless toner. The colorless toner was also applied at 0.45 mg/cm².

Subsequently, all toner images on the glossy, coated paper were fused as a group. For this purpose, a fuser roller was heated to a temperature of 160° C. The entire printing process was completed in a NexPress 2100® available from NexPress Solutions, Inc, of Rochester, N.Y.

The fully imprinted gloss papers were measured with the use of a Byk Gardener Gloss Meter at an angle of 60°, and in accordance with the provision, the Standard ASTM D 523. The results showed that the areas that were all formed by the K toner had a gloss value of 3.4. This value corresponds to the pleasant, dull appearance that is desirable for texts. The areas that were formed by the CMY toner and the K toner that was additionally applied with colorless toner, all had a uniform gloss value of 47. This value produces the high gloss that is desired for pictorial elements.

Thus, it is possible to cover areas of a printing format that are entirely of text with a dull gloss with a value of 3.4, while the areas that contain pictorial elements receive a high gloss with a value of 47.

The above was experimentally proven with respect to colorless toner and CMY toner with viscosities of 4.8 Pa·s and 6.2 Pa·s. For these experiments, K toners of varying viscosities were used, specifically.

The gloss value of the areas that were formed exclusively by K toner was solely a function of the viscosity of the K toner. Gloss values ranging between 1 and 3.4 were achieved.

The areas that were formed by CMY toner and colorless toner on top of K toner consistently had a uniform gloss value that was always solely a function of the viscosities of the binding agents of the CMY toner and the colorless toner. The same binding agent was used for both the CMY toner and the colorless toner.

At a viscosity of 4.8 Pa·s, a gloss value of 43 was obtained for these areas. At a viscosity of 6.2 Pa·s, a gloss value of 28 was obtained for these same areas.

1. A process for imaging a printing medium, in order to produce a higher gloss value in selected areas of a printing format, in areas that contain pictorial elements, during which such areas are imprinted prior to fusing with a colorless toner that has higher gloss values than at least one additional toner that is being used, characterized by said fact that for creating a higher gloss value of 28 to 47 at an angle of 60°, a clear toner with a viscosity in said range of 6.2 Pa·s and. 1.5 Pa·s, at a temperature of 120° C. is used.

2. A process according to claim 1, characterized by colorless and at least one additional toner are fused onto said printing medium in a contact-free method, preferably by a microwave fuser mechanism.

3. A colorless toner for obtaining a higher gloss value in desired areas of a printing format, in areas that contain pictorial elements, on a printing medium containing at least one additional toner that has lower gloss values, characterized by a gloss value that is between 28 and 47, at an angle of 60°, at a viscosity that is in said range of 6.2 Pa·s and 1.5 Pa·s, at a temperature of 120° C.

4. A colorless toner according to claim 3, characterized by a gloss value of 28, at a viscosity of 6.2 Pa·s.

5. A colorless toner according to claim 3, characterized by a gloss value of 43, at a viscosity of 4.8 Pa·s.

6. A colorless toner according to claim 3, characterized by a gloss value of 47, at a viscosity of 1.5 Pa·s.
